(19) United States
(12) Patent Application Publication
(10) Pub. No.: US 2008/0248345 A1
(43) Pub. Date: Oct. 9, 2008

(54) METHOD AND APPARATUS FOR ELECTROCHEMICAL ENERGY CONVERSION

(75) Inventors: Grigorii Lev Soloveichik, Latham, NY (US); Ji-Cheng Zhao, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/962,933

(22) Filed: Dec. 21, 2007

Related U.S. Application Data
(60) Provisional application No. 60/910,092, filed on Apr. 4, 2007.

(51) Int. Cl. H01M 8/18

(52) U.S. Cl. 429/17; 429/19

(57) ABSTRACT

An electrochemical energy conversion system comprises an electrochemical energy conversion device, in fluid communication with a source of liquid carrier of hydrogen and an oxidant, for receiving, catalyzing and electrochemically oxidizing at least a portion of said hydrogen to generate electricity, a hydrogen depleted liquid, and water; and a recharging component for connecting said electrochemical conversion system to a source of electricity for rehydrogenating the hydrogen depleted liquid across said electrochemical energy conversion device.

### CROSS REFERENCE TO RELATED APPLICATIONS

This application relates to, and claims priority from, provisionally filed US patent application having docket number 205589-1 and Ser. No. 60/910,092, entitled “HYDROGEN CARRIERS BASED ON AROMATIC NITROGEN CONTAINING HETEROCYCLIC COMPOUNDS”, filed on Apr. 4, 2007 and is related to co-pending patent application having a docket number of 205889-2 and a Ser. No. 11/766,970 entitled “METHOD AND APPARATUS FOR ELECTROCHEMICAL ENERGY CONVERSION”, which applications are hereby incorporated by reference.

### BACKGROUND

The invention relates generally to a method and apparatus for electrochemical energy conversion and more specifically to methods and apparatus of electrochemical energy conversion using a liquid carrier of hydrogen.

Proton exchange membrane (PEM) based fuel cells are considered to be effective electricity generators for both stationary and mobile applications. PEM fuel cells electrochemically react air with an external supply of fuel to produce electricity and typically have an energy density that is greater than conventional electrochemical batteries. Typical fuel for a PEM fuel cell is hydrogen. Effective hydrogen storage remains a challenge, especially for mobile applications. High pressure or liquid hydrogen storage options are too expensive and typically have a low volumetric energy density. Current solid materials for hydrogen storage operating at temperatures below the typical operating temperatures of PEM fuel cells (100 C) are currently capable of storing only about 4 wt. % and require a sophisticated heat management system that reduces total system capacity by about 50%. In addition such materials require total redesign of cars and refueling infrastructure. Liquid fuels like methanol also can be used in PEM fuel cells. However, these fuels generate CO₂ and CO that poisons the fuel cell catalyst. The most effective type of fuel for a PEM fuel cell is methanol that is a very toxic and highly flammable liquid. The use of a diluted methanol fuel reduces these risks but also substantially reduces the system energy density.

To improve the energy density of the PEM fuel cell system, many efforts are focused on improvement of the hydrogen storage subsystem. Some high capacity metal hydride options currently exist but they are either irreversible or work reversibly at much higher temperatures than the fuel cell operates. The recharge of these hydrides involves a high rate of heat dissipation and therefore additional components such as a heat exchanger.

Accordingly, there is a need in the art for an improved electrochemical energy conversion system that overcomes some of the limitations of the current PEM fuel cell and hydrogen storage limitations.

### BRIEF DESCRIPTION

An electrochemical energy conversion system comprises an electrochemical energy conversion device, in fluid communication with a source of liquid carrier of hydrogen and an oxidant, for receiving, catalyzing and electrochemically oxidizing at least a portion of said hydrogen to generate electricity, a hydrogen depleted liquid, and water; and a recharging component for connecting said electrochemical conversion system to a source of electricity for rehydrogenating the hydrogen depleted liquid across said electrochemical energy conversion device.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of one embodiment of the instant invention.

FIG. 2 is a schematic illustration of another embodiment of the instant invention.

FIG. 3 is schematic of an experimental setup in accordance with another embodiment of the instant invention.

FIG. 4 is a schematic illustration of another embodiment of the instant invention.

### DETAILED DESCRIPTION

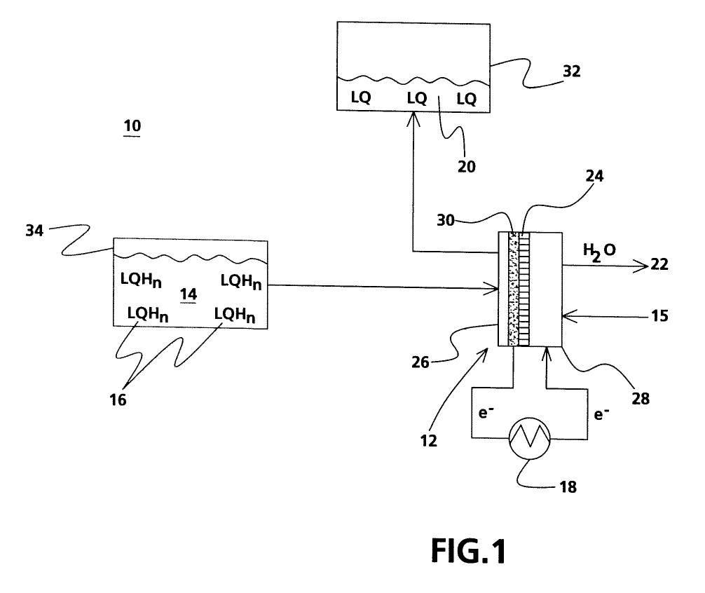

An electrochemical energy conversion system 10 comprises an electrochemical energy conversion device 12 in fluid communication with a source of a liquid carrier of hydrogen 14 (LQHₙ) and an oxidant 15, typically air, purified oxygen or their mixture, as shown in FIG. 1. The electrochemical energy conversion device 12 receives, catalyzes and electrochemically oxidizes at least a portion of the hydrogen 16, contained in the liquid carrier of hydrogen LQHₙ 14, to generate electricity 18, a hydrogen depleted liquid LQ 20, and water 22. Hydrogen depleted liquid LQ 20 may include both fully hydrogen depleted liquids and partially hydrogen depleted liquids. While the appropriate liquid carrier of hydrogen 14 will vary from system to system, the selection process will typically be based on criteria such as the hydrogen storage capacity of the carrier, the rate and the heat of dehydrogenation of the carrier, the boiling point of the carrier and the overall cost of the carrier.

In one embodiment, electrochemical energy conversion device 12 comprises a Proton Exchange Membrane (PEM) fuel cell that includes a solid electrolyte 24 that separates an anode portion 26 and a cathode portion 28. PEM fuel cell 12 further comprises a catalyst 30, typically disposed on the anodic side of the solid electrolyte 24, for accelerating the disassociating and oxidation of hydrogen 16 from the liquid carrier of hydrogen 14. In one embodiment, catalyst 30 comprises palladium, platinum, rhodium, ruthenium, nickel and combinations thereof. In another embodiment, the catalyst 30 is a group VIII metal, such as finely dispersed metal alloys and transition metal complexes with multidentate P- or N-containing ligands (e.g. “pincer” type) on high-surface-area conductive supports like carbon or conductive polymers. In one embodiment, the catalyst 30 will be anchored to the anode portion 26 via formation of chemical bonds between the catalyst 30 and the anode portion 26, for example, by using functionalized silanes or by adsorption on a ligand-modified surface. In one embodiment, the system 10 may further comprise a catalyst material (not shown) on the cathode portion 28 to increase the electrochemical cell potential and improve the oxygen reduction reaction.

System 10 further comprises a storage tank 32 for storing the hydrogen depleted liquid 20. The solid electrolyte 24 typically comprises a membrane, for example Nafion®, which membrane is compatible with the liquid carrier of hydrogen 14 and the catalyst 30. In another embodiment, the solid electrolyte is a high-temperature membrane based on composites of proton-conductive ceramics and high-heat polymers (for example, polysulfones or polybenzimidazoles). In addition to the oxidant 15, a quantity of water vapor may be directed into the system to keep the solid electrolyte 24 hydrated for better proton conductivity,

In one embodiment, the liquid carrier of hydrogen 14 is an organic liquid carrier of hydrogen. In another embodiment, the liquid carrier of hydrogen 14 is a cyclic hydrocarbon. In another embodiment, the liquid carrier of hydrogen is a partially or fully hydrogenated nitrogen-containing aromatic heterocycle, for example, 2-aminopyridine, 4-methylpyrimidine, dipyrimidinemethane, dimethyltetrazine, dipirimidine, diazacarbazole, alkylcarbazole, 4-aminopyridine, dipyrazinemethane, tripyrazinemethane, tripyrazineamine, dipyrazine, tetrazacarbazole, isoquinoline, di(2-pyridyl)amine, quinazoline, and combinations thereof. In yet another embodiment, the liquid carrier of hydrogen 14 is a partially or fully hydrogenated aromatic hydrocarbon, for example naphthalene, benzene, anthracene, and combinations thereof. In yet another embodiment, the liquid carrier of hydrogen 14 is one of perhydro-N-ethylcarbazole, cyclohexane, tetrahydroisoquinoline, tetraline, decaline, and combinations thereof.

In some embodiments, the liquid carrier of hydrogen 14 may include certain additives to improve its flow characteristics or enhance the electrochemical reaction that occurs at the electrochemical energy conversion device 12.

In operation, the liquid carrier of hydrogen 14, for example an organic liquid carrier, is directed (typically from a tank 34 or the like) to the electrochemical energy conversion device 12, where the liquid carrier is electrochemically dehydrogenated in the presence of a catalyst to produce electricity 18. As discussed above, several limitations exist in the current PEM fuel cell and hydrogen storage systems including the lack of a high-capacity hydrogen storage medium and the incompatibility of such systems with the existing fueling and transportation infrastructure. The current invention, however, provides a high-capacity energy storage solution, as several liquid carriers of hydrogen exceed 7-wt % hydrogen storage capacity. At a capacity of 7 wt. % hydrogen, a 20-gallon tank of an organic liquid carrier will provide about 5 kg equivalent of hydrogen enabling about a 300-mile drive. In addition, because the energy storage solution is based on a liquid carrier, the existing re-fueling and transportation infrastructure can be utilized without substantial modification.

Other benefits of the instant invention are that the electricity 18 is produced from the electrochemical energy conversion device 12 without the production of a hydrogen gas, making utilization and storage concerns, safety and size much easier to deal with. Furthermore, the hydrogen-depleted organic liquid 20 can be re-hydrogenated via on-board electrolysis (when used in a plug-in mode) or off-board (when used in a fuel cell vehicle mode). Thus, system 10 is both an attractive hydrogen storage solution and a high-capacity energy storage solution. Accordingly, this system provides a single hydrogen/energy storage solution for a combined plug-in electric and pure hydrogen fuel cell vehicles. As a hydrogen storage solution, the system 10 has the advantage of being able to use the existing re-fueling infrastructure. As a plug-in solution, the system 10 can be recharged at night, thus regenerating fuel cost effectively and easing the distribution of at least part of the overall energy for transportation via existing electrical grids instead of through fuel transportation and distribution networks.

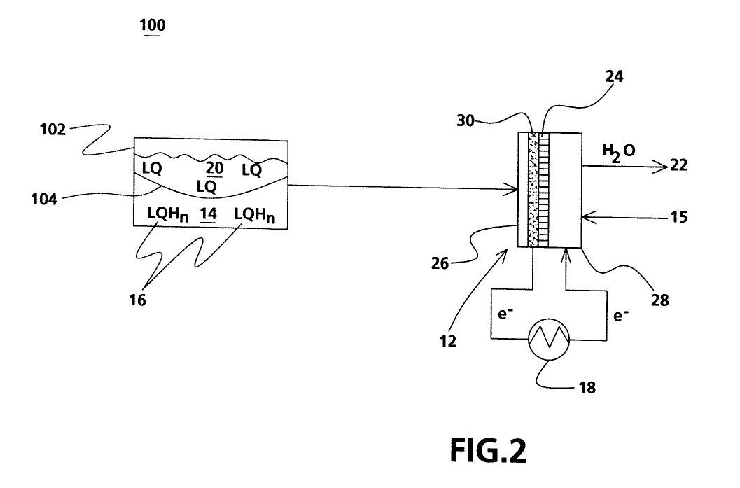

Another embodiment of an electrochemical energy conversion system 100 is shown in FIG. 2. System 100 combines the two storage tanks required in system 10 and utilizes a single storage tank or vessel 102 comprising a separator 104, for example a membrane separator, that divides the storage tank or vessel 102 into multiple portions to store both the liquid carrier of hydrogen 14 and the hydrogen depleted liquid 20. In another embodiment, the membrane separator 104 is a flexible diaphragm. Such an arrangement makes the system 100 much more compact and efficient, especially in the re-fueling process. While the system 100 shows the liquid carrier of hydrogen 14 in a bottom portion of the tank 102 and the hydrogen depleted liquid 20 in a top portion of the tank 102, it is contemplated that those positions could be altered and potentially many other segmentation configurations would be within the spirit of this invention.

The chemistry involved within the instant invention can be summarized as follows. Partial electro-oxidation of the liquid carrier of hydrogen 14, for example an organic carrier, in the presence of an electrocatalyst 24 generates protons (Equation 1), where LQ stands for a hydrogen depleted organic carrier molecule.

LQ*Hₙ→LQ+nH⁺+ne⁻ (1)

Generated protons travel through the solid electrolyte 24 and combine with reduced oxygen at the cathode 28 to generate water 22 (Equation 2).

n/2O₂+nH⁺→n/2H₂O−ne⁻ (2)

The total reaction is described by Equation 3.

LQ*Hₙ+n/2O₂→LQ+n/2H₂O (3)

In these equations, all reactions are reversible, which allows the fuel cell to be used as an electrolyzer for recharging of the organic carrier. In the discharging mode, the cell is a flow battery in which high energy hydrogenated fuel is stored separately from the electrochemical cell thus increasing the system energy density. Known flow batteries (vanadium, zinc-bromine) with liquid electrolyte have flexible layouts, and high power and capacity but cannot be used for most applications, including mobile applications, due to the low energy density of the electrolyte (75-140 Wh/kg). The calculated energy densities of certain liquid carriers of hydrogen 14, such as organic liquid carriers are in the range between about 1550 to about 2000 Wh/kg. The use of a direct rechargeable fuel cell as a flow battery will make the energy density of the total hydrogen storage and utilization system close to the theoretical limit, and suitable for mobile applications.

The off-board hydrogenation of organic cyclic and heterocyclic molecules can be accomplished in relatively mild conditions (e.g. 100° C., 7 bar hydrogen) with the appropriate catalyst (high surface area Ni or supported Pt) to yield the saturated molecule with good conversion and turnover rates. However, dehydrogenation, the reverse reaction, is highly endothermic and strongly limited by thermodynamic equlibria. Catalytic thermal dehydrogenation of cyclic hydrocarbons usually requires high temperature (>200° C.) and has slow kinetics. Electrochemical dehydrogenation, as discussed in the current invention, however, can be conducted at lower temperatures and at higher rates.

To calculate the theoretical open circuit voltage (OCV) of an exemplary electrochemical energy conversion device 12 for different carriers, the ΔG (Gibbs energy) of reaction was used (3), as shown above. ΔG can be calculated from ΔG of two reactions (4 and 5). The parameters of hydrogen oxidation reaction are well known, and ΔG of reaction 4 is known for some molecules and can be estimated based on theoretical calculations for others. This approach gives OCV values for various organic carriers in the range between about 950 to about 1020 mV. The higher the heat of dehydrogenation, the lower the fuel cell OCV.

LQ*Hₙ→LQ+n/2H₂ (4)

H₂+½O₂→H₂O (5)

### EXAMPLE

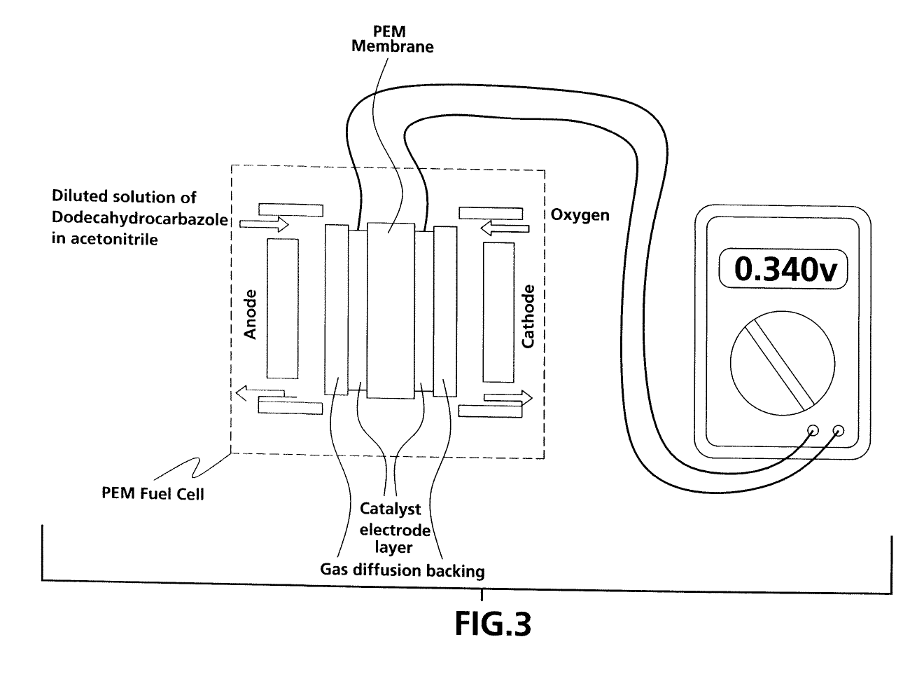

Experiments with the use of a liquid hydrogenated carbazole demonstrated the use of liquid organic compounds as a fuel in an electrochemical energy conversion device. A hydrogen fuel cell with platinum catalyst, as shown in FIG. 3, was filled with a diluted solution of dodecahydro-N-ethylcarbazole in acetonitrile and demonstrated an OCV of 340 mV with oxygen as an oxidant at room temperature. Using a carbon black/Ni/Pt—C electrode with dodecahydro-N-ethylcarbazole as the carrier increased the OCV to 650 mV.

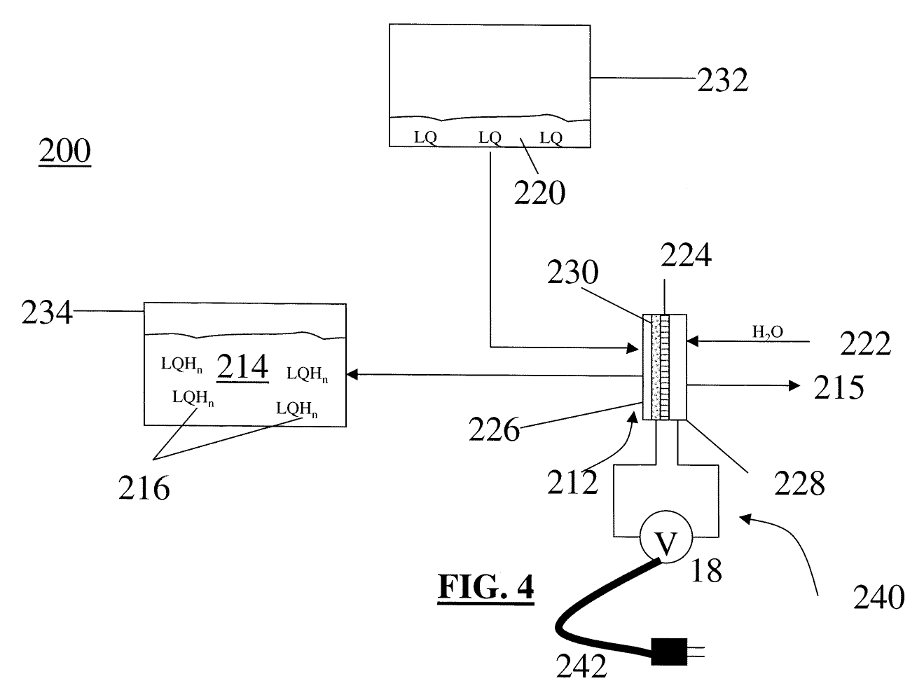

In another embodiment of the instant invention, a rechargeable energy conversion system 200 is shown in FIG. 4. Rechargeable energy conversion system 200 further comprises a recharging component 240 that applies a voltage across the fuel cell and rehydrogenates the depleted liquid carrier 220 into the liquid carrier of hydrogen 216. The recharging component 240 is connected to a source of DC electricity (not shown) for example a wall outlet via an AC/DC inverter, energy storage device or any other source of electricity typically via a plug 242 or other connection. In operation, the depleted liquid carrier 220, is directed (typically from a tank 232 or the like) to the electrochemical energy conversion device 212, where the depleted liquid carrier 220 is electrochemically hydrogenated in the presence of a catalyst and a source of water 222 (for example from an on-board storage tank or household source of water) to produce a rehydrogenated liquid carrier of hydrogen 214 and oxygen. In this embodiment, the electrochemical conversion device 212 operates as an electrolyzer, and electrochemically charges the depleted liquid carrier 220 using water electrolysis. The advantage of this electrochemical re-charging mode is that fuel can be regenerated cost effectively. Distribution of at least part of the overall energy for transportation can be supplied via existing electrical grids instead of transporting pure hydrogen, which is still a challenge.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electrochemical energy conversion system comprising:
an electrochemical energy conversion device, in fluid communication with a source of liquid carrier of hydrogen and an oxidant, for receiving, catalyzing and electrochemically oxidizing at least a portion of said hydrogen to generate electricity, a hydrogen depleted liquid, and water; and
a recharging component for connecting said electrochemical conversion system to a source of electricity for rehydrogenating the hydrogen depleted liquid across said electrochemical energy conversion device.

2. An electrochemical energy conversion system in accordance with claim 1, wherein said liquid carrier of hydrogen is an organic liquid carrier of hydrogen.

3. An electrochemical energy conversion system in accordance with claim 1, wherein said liquid carrier of hydrogen is a saturated cyclic hydrocarbon.

4. An electrochemical energy conversion system in accordance with claim 1, wherein said liquid carrier of hydrogen is a partially or fully hydrogenated nitrogen-containing aromatic heterocycle.

5. An electrochemical energy conversion system in accordance with claim 4, wherein said liquid carrier of hydrogen is a partially or fully hydrogenated nitrogen-containing aromatic compound selected from the group consisting of 2-aminopyridine, 4-methylpyrimidine, dipyrimidinemethane, dimethyltetrazine, dipirimidine, diazacarbazole, alkylcarbazole, 4-aminopyridine, dipyrazinemethane, tripyrazinemethane, tripyrazineamine, dipyrazine, tetrazacarbazole, isoquinoline, di(2-pyridyl)amine, quinazoline, and combinations thereof.

6. An electrochemical energy conversion system in accordance with claim 1, wherein said liquid carrier of hydrogen is a partially or fully hydrogenated aromatic hydrocarbon.

7. An electrochemical energy conversion system in accordance with claim 1, wherein said liquid carrier of hydrogen further comprises an inert additive to facilitate the liquid flow.

8. An electrochemical energy conversion system in accordance with claim 1, wherein said liquid carrier of hydrogen further comprises an additive to enhance the electrochemical reaction.

9. An electrochemical energy conversion system in accordance with claim 1, wherein said electrochemical energy conversion device is a PEM fuel cell operated in a first direction and a PEM electrolyzer operated in a second direction.

10. An electrochemical energy conversion system in accordance with claim 1, further comprising a catalyst.

11. An electrochemical energy conversion system in accordance with claim 1, wherein said source of electricity is at least one of a source of DC electricity, a wall outlet, or an energy storage device.

12. An electrochemical energy conversion system in accordance with claim 1, further comprises a source of water.

13. An electrochemical energy conversion system in accordance with claim 13, wherein said source of water is at least one of an onboard storage tank or a household source of water.

14. An electrochemical energy conversion system comprising:
a storage tank for a source of liquid carrier of hydrogen;
a PEM fuel cell, in fluid communication with said storage tank and an oxidant, for receiving, catalyzing and electrochemically oxidizing at least a portion of said hydrogen containing within said liquid carrier of hydrogen to generate electricity, a hydrogen depleted liquid, and water; and
a recharging component for connecting said electrochemical conversion system to a source of electricity for rehydrogenating the hydrogen depleted liquid across said electrochemical energy conversion.

15. An electrochemical energy conversion system in accordance with claim 24 wherein said solid electrolyte is selected from the group consisting of Nafion, composites of proton-conductive ceramics and high-heat polymers.

16. A method of electrochemical energy conversion comprising the steps of:
directing a liquid carrier of hydrogen to an electrochemical conversion device;
electrochemically dehydrogenating said liquid carrier of hydrogen in the presence of a catalyst to produce electricity and a hydrogen depleted liquid;
directing said hydrogen depleted liquid to said electrochemical conversion device; and
electrifying said electrochemical conversion device to rehydrogenate said hydrogen depleted liquid.
